(19) United States
(12) Patent Application Publication
(10) Pub. No.: US 2024/0015418 A1
(43) Pub. Date: Jan. 11, 2024

(54) SYSTEM FOR DECENTRALIZED ACQUISITION AND WIRELESS TRANSMISSION OF ACQUIRED DATA FOR USE UNDERGROUND

(71) Applicant: Technische Universität Bergakademie Freiberg, Frieberg (DE)

(72) Inventors: Hans-Günther KRUG, Schulzendorf (DE); Tobias KRICHLER, Freiberg (DE); Helmut MISCHO, Oberschöna OT Bräunsdorf (DE)

(73) Assignee: Technische Universität Bergakademie Freiberg, Frieberg (DE)

(21) Appl. No.: 18/257,421

(22) PCT Filed: Dec. 14, 2021
(86) PCT No.: PCT/EP2021/085593

§ 371 Date: Jun. 14, 2023

(30) Foreign Application Priority Data
Dec. 18, 2020 (DE) 10 2020 216 221.2

(51) Int. Cl. H04Q 9/00; H04L 67/12

(52) U.S. Cl. CPC H04Q 9/00; H04L 67/12; H04Q 2209/50; H04Q 2209/20; H04Q 2209/40

(57) ABSTRACT

In the system, the data, which are acquired in a decentralized manner, are evaluated centrally. Multiple at least temporarily mobile modules are arranged at various positions of a respective underground structure and the temporarily mobile modules are designed to acquire and buffer store measurement data and to transmit acquired measurement data wirelessly and automatically to multiple fully mobile modules as soon as a fully mobile module has reached a distance from a temporarily mobile module at which a wireless data transmission between a respective temporarily mobile module and a fully mobile module is possible. Fully mobile modules are designed to buffer store data that have been received from at least one temporarily mobile module and, upon reaching a data access point that is connected to a central acquisition, evaluation and/or storage unit, to transmit these buffer-stored data to the respective data access point.

The invention relates to a system for the decentralized acquisition and wireless transmission of acquired data for use underground.

The present invention describes a decentralized communication and data transmission system that has been primarily developed for use in underground mines, but can also be used in all other facilities, tunnels, and mines both above ground and underground. The data transmission takes place wirelessly without any permanent connection. The measurement stations/data loggers can be randomly distributed and acquire and store their data. As soon as a receiver (e.g. a vehicle having an installed data collector) is located in the range of the measurement station, the data are transmitted in an automated manner and can be transmitted from the receiver into the higher ranking system, e.g. via Ethernet to a central point having a wireless LAN access point (workshop, screening). A receiver can here access as many measurement stations as desired and can record their data since they can always be accurately associated via an internal identifier and a time stamp. Each measurement station can equally connect to every legitimized receiver to thus implement the data flow as continuously as possible. The time delay can thus be reduced from previously hours or days to a few minutes and primarily depends on the distance of the receiver to be traveled.

The data transmission in the underground sector represents a great challenge since the above ground wireless transmission options such as UMTS, LTE, wireless LAN, internet via satellite, etc. cannot be used to the known extent. The transmission distances are reduced to a minimum in a mine so that currently primarily wired solutions are used for which purpose the total mine primarily have to be equipped with optical waveguides or other suitable wired data transmission possibilities. Access points are installed at important locations, whereby access is possible in principle from any point in the mine. Alternatively, wireless LAN can be used since the mine can be networked via a sufficiently dimensioned number of repeaters. A wireless transmission is equally possible within a limited region via the use of leaky feeders.

The decisive disadvantage of these variants are the high installation and maintenance costs that arise due to two major features of a mine. They are the movability and three-dimensionality.

Resources are excavated in a mine so that the mine grows and changes with every day. At the same time, other regions are mothballed, that is closed. A reworking/expansion of the network for data transmission thus theoretically has to take place almost every day in principle. Long distances moreover additionally arise that are of subsidiary relevance since hardly any new information can be recorded therein. To ensure data transmission, these regions nevertheless have to be equipped with network technology.

The second feature, relating to the three-dimensionality, primarily makes itself noticeable by the following problem. A storage facility often spreads over many 100 m in depth and can therefore not be excavated with only one point of attack. A plurality of levels have to be screened at different depths and have to be operated simultaneously due to excavation and conveying. Since the data transmission has to be ensured for every level, great demands quickly arise on the required infrastructure.

These features consequently have the result that both the setup and the servicing, maintenance, and updating of a data transmission system to be used underground becomes a high cost factor that can hardly be implemented for small and medium-sized mines. There is additionally the fact that comparatively few data are acquired in many regions of a mine, whereby the setting up with current technologies is overdimensioned there.

Loaders with data loggers are already being used that store the data over the whole shift and transmit the data at the earliest at the end of the shift or only on the next servicing. It is, however, disadvantageous here that all the data are up to 8 h old and fast intervention is not possible.

A further current approach deals with a long wave transmission through the earth, abbreviated to TTE. Distances of up to 150 m transversely through the rock can be implemented due to the very long wave transmission. The very low data transmission rate is, however, problematic in this approach. The principle applies here: The higher the wavelength and the lower the frequency, the lower the transmittable data rate. In addition, a secure transmission should be ensured, for which purpose the telegrams contain a protocol overhead that further reduces the transmittable volume of measured data that are actually of interest.

It is therefore the object of the invention to provide possibilities for a decentralized communication and data transmission system for facilities, tunnels, and mines underground, wherein a configurable data acquisition and a decentralized data transmission should be possible within an underground mine or construction site without a complete wiring/networking and without permanent constant communication.

In accordance with the invention, this object is achieved by a system having the features of claim 1. Advantageous embodiments and further developments can be implemented using features designated in the subordinate claims.

A plurality of at least temporarily mobile modules are arranged at different positions of a respective underground construction sites in the system. The temporarily mobile modules are configured such that they acquire measured data, buffer them, and transmit acquired measured data wirelessly and automatically to a plurality of fully mobile modules as soon as a fully mobile module has reached a distance from a temporarily mobile module at which a wireless data transmission between a respective temporary mobile module and a fully mobile module is possible.

Fully mobile modules are further configured to buffer data that have been received from at least one temporarily mobile module and to transmit these buffered data to the respective data access point on reaching a data access point that is connected to a central acquisition, evaluation, and/or storage unit; and

the temporarily mobile modules are further configured only to wirelessly transmit buffered measured data after receipt of a wirelessly received request signal that has been transmitted by a fully mobile module to the respective temporarily mobile module.

For this purpose, temporarily and fully mobile modules should have possibilities for the wireless transmission and reception of signals, that is transmission and reception signals.

Temporarily mobile modules can in particular be measurement stations having at least one sensor for acquiring measured data. A temporarily mobile module can also be called a measurement station in the following. A fully mobile module can be installed at a vehicle or can be integrated thereon. A vehicle can be all the vehicles that can be used underground. This also refers to transport vehicles that can be equipped with a fully mobile module.

A temporarily mobile module can be positioned as required at a suitable or required location, with a change of location also being able to be possible. It can take place in an adaptation to conditions changing for operational or work reasons underground.

Transmission of data from a temporarily mobile module to a fully mobile module and/or from a fully mobile module to a data access point should preferably take place serially by means of a communication protocol. Not only acquired measured data can be transmitted using a communication protocol. A time signal associated with the respective measured data and/or at least one identification code for the respective mobile module should rather also be transmitted.

Data acquired from a temporarily mobile module should preferably be transmitted bytewise as unprocessed raw data, whereby the data volume to be transmitted can be reduced. The data transmission should be secured, in particular encrypted, and an association and decoding or decrypting should subsequently take place by means of an identification code specific to a respective temporarily mobile module in the central acquisition, evaluation, and/or storage unit.

Measured data acquired by temporarily mobile modules can also be wirelessly transmitted via at least one repeater to a buffer module. A respective buffer module should be configured such that it can store measured data wirelessly received from at least one temporarily mobile module and can transmit the buffered data to a fully mobile module on receipt of a request signal from this fully mobile module. Underground regions can thus be bridged that are rarely reached or not reached at all by fully mobile modules.

More than one access point can also be present underground. A plurality of access points are then each connected to the central acquisition, evaluation, and/or storage unit.

A temporarily mobile module can be configured to determine the concentration of at least one chemical element or at least one chemical compound in the environmental atmosphere, the temperature, the relative humidity, the atmospheric pressure, the presence of living beings, machine data, or resource data. Other data operationally relevant to the operator can also be determined. A temporarily mobile module can here also be configured such that it can determine the number and optionally the location of persons that are located in its observation zone. This is e.g. possible using suitable video technology that can also be sensitive in the infrared range. This list of possible sensor systems can be expanded as desired since there is no restriction to the kind and type of the sensor.

Mobile modules that can also be called data loggers/data memories can be used in the invention in combination with radio modules. The temporarily mobile modules that acquire the measured data (measurement stations) can be set up freely in the total field or can be installed on machines. Vehicles and machines (e.g. passenger transporters, supervisor vehicles, dumper trucks, tipper trucks) that regularly travel from remote points of a mine (e.g. excavation/heading) to the central parts of the mine (e.g. screening/workshop) connect to the temporary mobile modules when driving past and collect their measured data that they buffer up to their further transmission to a centrally disposed access point. The measured data can subsequently be fed into an intranet in central regions of the mine (workshop, screening, etc.) and can then be visualized, evaluated, and stored in a central acquisition, evaluation, and/or storage unit. The installation and servicing can thus be substantially reduced with respect to fully networked mines.

Since, for example, the dumper trucks have to permanently transport both the excavated resource and the country rock from the excavation to the screening as or by a fully mobile module, a regular transport and thus also a wireless data transmission can also be ensured over a certain distance over a plurality of regions of a mine construction such as routes arranged above one another, whereby the time delay on a data transmission can be substantially reduced in comparison with the currently used, not fixedly wired or fully networked technologies.

The invention relates to the wireless transmission of data within an underground region. A serial master/slave communication, e.g. based on the binary synchronous communication protocol of IBM should be used between temporary and fully mobile modules, but also between fully mobile modules and a data access point or a buffer module. The communication here takes place in a decentralized form between the different modules or a buffer module and at least one data access point.

Measurement stations having data loggers (called “measurement stations” in the following) that act as slaves in the communication can be installed at any desired location of the underground region and initially buffer their acquired or measured data. As soon as a vehicle (e.g. dumper truck, supervisor vehicle, convoy vehicle) having a data collector/cache as a fully mobile module (called a “data collector” in the following), that acts as a master in the communication, travels past one of the measurement stations, a serial wireless connection should be set up between both participants and the data should be transmitted to the data collector. The system is thus highly flexible since the measurement stations can be installed at any position and can also change their positions at any time. The requirement is an electrical power supply that can be implemented as desired (e.g. mains connection or rechargeable battery). The conversion of the raw data acquired by the measurement station into measured data should only take place above ground to ensure a robust system underground. The bytewise forwarding of the raw data into existing infrastructure via existing interfaces into different measurement systems is possible here. A data collector of a fully mobile module can communicate exclusively consecutively with any desired number of measurement stations and can buffer the existing measured data until it can forward them to a higher ranking central acquisition, evaluation, and/or storage unit (e.g. via an access point-data access point into the intranet of a mine). As many data collectors as desired can be integrated for the data transport. A plurality of masters can simultaneously communicate with different slaves without influencing one another due to the unique identifier of the master and slave. As soon as a data collector connects to a higher ranking system (e.g. another measurement station via ProfiNet, wireless LAN, . . . ), all the data of the measurement stations traveled to can be transmitted to the higher ranking communication systems by the data collector. Software that has been stored in a central acquisition, evaluation, and/or storage unit can evaluate all the information in that the messages acquired by temporary mobile units and transmitted from there are first divided into control characters, structural data, and measured data. The measured data can subsequently be converted via the structural data (e.g. byte to float). An identification code (slave number) internally assigned to a measurement station can here always be used for the localization and for the unique addressing of the respective measurement station. The encoding of structural data can be modified for every mine, whereby a first data security can be achieved since the data can only be evaluated with the aid of the unique encoding. Since a large number of machines have round-trip times of less than 15 minutes in mining, the delay between the data acquisition and the data evaluation can be minimized. The data can be transmitted both in a secured (e.g. via a CRC) and unsecured manner. Acquired measured data can be transmitted as raw data to maximize the achievable bandwidth. An encryption of the data can be achieved via an encryption code, e.g. a slave identifier. An encryption can, however, also be expanded using conventional encryption methods. The conversion of the acquired raw data into measured data that can be evaluated can take place on the transmission of both raw data and of encrypted data above ground by suitable evaluation software in an acquisition, evaluation, and/or storage unit.

Remote regions underground that are only rarely traveled and thus have high delays in the data transmission can be connected to the central regions of the mine via repeaters to minimize the time delay. Repeaters can be installed in series for this purpose and forward the obtained data directly until the data with respect to a location having an increased volume of traffic have been transmitted to a buffer module that is configured to receive the measured data acquired by the temporarily mobile modules and to transmit these data to fully mobile module, whereby a regular data transmission and synonymously a smaller delay can be ensured.

All the temporarily mobile modules are freely configurable and specifically programmable to their respective application. This enables a uniform, specific setup for all the measurement stations and data collectors, with only the contained data changing since the framework of the data transmission is always the same due to the specification of the respective transmission protocol. This setup enables the expansion of the existing system (further measurement stations or data collectors) at any time without existing modules necessarily having to be updated. Since a data collector typically does not evaluate the data, but only buffers them and forwards them to the higher ranking system, the acquired measured data are independent of the transmission protocol used. New measurement stations can therefore be integrated as temporarily mobile modules into the existing system at any time. For the evaluation, only an updating of the software is necessary here for the data evaluation that can translate these raw data into useful data.

A reduction of the required infrastructure can be achieved with the invention in comparison with communication systems on an 802.11 basis by using radio transceivers in combination with microcontrollers that can be used for the data transmission between the different modules. Substantial savings in the energy consumption of the measurement stations (slaves) hereby result since they only transmit if they have previously been addressed by a fully mobile module (master) and consist of microcontrollers. A long-term monitoring via battery operation in the regions not connected to the energy supply and thus remote is thus also possible.

A cyclic, regular data transmission to a higher ranking module can also be implemented by the user of a plurality of data collectors with a simultaneously uninterrupted data transmission on a failure of individual measurement stations or data collectors.

There is an independent connection possibility of each measurement station integrated in the system to each data collector.

In addition to a minimization of the data flow between the measurement station and the data collector by bytewise transmission of raw data that are only converted into readable data by a central acquisition, evaluation, and/or storage unit, a maximization of the possible buffering on the measurement stations and data collectors is possible since only raw data are buffered.

A simple, freely configurable and robust data transmission is possible without additionally required updates by specifically configured measurement stations that can be read out by the data collector independently of their measured data. The measurement stations thus only have to be programmed once to their specific use and do not require any update. The data collectors can communicate with every measurement station by the transmission protocol, whereby any desired measurement stations can subsequently be added to the system. The translation and evaluation of the measured data takes place in a central evaluation program above ground (transmission of raw data), whereby the data security is also increased. The central evaluation program can be easily expanded with new modules (new measurement stations).

In practice, a central acquisition, evaluation, and/or storage unit can, for example, be installed in a main building of a mine in which the mine control station or the workplaces and computers of the supervisors are located. It is normally located above ground.

The core regions of a mine that are reached through a shaft or an adit are usually equipped with a data transmission on an IEEE 802.11 basis so that it can be considered as prior art. An Ethernet connection of at least one data access point to a central acquisition, evaluation, and/or storage unit can thus be present, for example, in a central mine construction (e.g. bunkers, crushers, or underground screening). The wireless and automatic data transmission from the fully mobile modules and from the data access point to the central acquisition, evaluation, and/or storage unit can take place at the data access point. All the further regions of the mine no longer have to access the typical communication media, but can rather be equipped with and reached via the new decentralized communication system. The decentralized system can here additionally be integrated in an already existing network. It can also be added in combination with other tools for wireless transmission between machines.

A ramp or alternatively a spiral enables the locomotion of the different fully mobile modules within the mine at different depths. Neither the excavation direction nor the excavation method have aby influence on the use of the system.

Measurement stations that can be arranged as desired and as required underground can be read by every data collector and are therefore freely positionable here. The position of measurement stations is hereby in particular selectable by the temporarily mobile modules independently of the infrastructure of the underground facility, whereby the decentralized system for communication can be used extremely flexibly by the operation with mobile machines as fully mobile modules. The distance from the higher ranking communication system and the frequenting of the measurement station determine the time delay here.

In the real case, every vehicle can be equipped with data collectors as fully mobile modules. The dumper truck as an example for a fully mobile module can transport all the mining relevant materials (e.g. ore, tailings, filling, . . . ) into all the regions of the mine and can at the same time provide a continuous data flow from measurement stations to a data access point. A continuous data flow with only a slight delay can thus also be implemented from the time of the acquisition of measured data. A supervisor typically makes his daily round and can record the data of temporarily mobile modules at less frequently visited locations here and can transmit them to the higher ranking communication system via a data access point to the central acquisition, evaluation, and/or storage unit. As a third example, the heading has to be traveled to by a further dumper truck and transports its debris to above ground. Since it travels past the central mine construction, the data of the heading can thus likewise be regularly transmitted to the central acquisition, evaluation, and/or storage unit via a data access point or directly. It is possible via the setting up of a repeater network to transmit the acquired measured data from remote positions up to central positions such as a main conveying path (e.g. ramp) to a buffer module where they can be continuously recorded and transmitted by the different data collectors of fully mobile modules. The data of an exploratory drilling or of the heading could thus, for example, be transmitted with a considerably smaller transmission delay to the central acquisition, evaluation, and/or storage unit.

1-7. (canceled)

8. A system for the decentralized acquisition and wireless transmission of acquired data for use underground in which a central evaluation of the data acquired in decentralized form takes place, comprising:
a plurality of at least temporarily mobile modules are arranged at different positions of a respective unground mine and the temporarily mobile modules are configured to acquire measured data, buffer them, and transmit acquired measured data wirelessly and automatically to a plurality of fully mobile modules as soon as a fully mobile module has reached a distance from a temporarily mobile module at which a wireless data transmission between a respective temporary mobile module and a fully mobile module is possible; and
fully mobile modules are further configured to buffer data that have been received from at least one temporarily mobile module and to transmit these buffered data to a respective data access point on reaching the data access point that is connected to a central acquisition, evaluation, and/or storage unit; and
the temporarily mobile modules are further configured only to wirelessly transmit buffered measured data after receipt of a wirelessly received request signal that has been transmitted by a fully mobile module to the respective temporarily mobile module.

9. The system in accordance with claim 8, wherein a temporarily mobile module is a measurement station having at least one sensor for acquiring measured data; and in that a fully mobile module is installed in or integrated at a vehicle.

10. The system in accordance with claim 8, wherein a transmission of data from a temporarily mobile module to a fully mobile module and/or from a fully mobile module to a data access point takes place serially by means of a communication protocol.

11. The system in accordance with claim 8, wherein data acquired by a temporarily mobile module are transmitted bytewise as unprocessed raw data.

12. The system in accordance with claim 8, wherein the data transmission takes place in a secured, encrypted form, and an association and decoding or decrypting subsequently takes place via an identification code specific to a respective temporarily mobile module in the central acquisition, evaluation, and/or storage unit.

13. A system in accordance with claim 8, wherein measured data acquired by temporarily mobile modules can be wirelessly transmitted via at least one repeater to a buffer module and a respective buffer module is configured to store the measured data wirelessly received from at least one temporarily mobile module and to transmit the buffered measured data to a fully mobile module after receipt of a request signal from this fully mobile module.

14. A system in accordance with claim 8, wherein a temporarily mobile module is formed that determines the concentration of at least one chemical element or at least one chemical compound in the environmental atmosphere, the temperature, the relative humidity, the atmospheric pressure, the presence of living beings, machine data, resource data, or operating states of plants and devices.
